(19) United States
(12) Patent Application Publication
(10) Pub. No.: US 2022/0277118 A1
(43) Pub. Date: Sep. 1, 2022

(54) Multi-Component Simulation Method and System

(71) Applicant: University of Leeds, Leeds (GB)

(72) Inventors: Jie XU, Leeds (GB); David Wesley MCKEE, Leeds (GB); Stephen James CLEMENT, Leeds (GB); David James BATTERSBY, Coventry (GB)

(21) Appl. No.: 17/632,731

(22) PCT Filed: Aug. 6, 2020
(86) PCT No.: PCT/GB2020/051879

§ 371 Date: Feb. 3, 2022

(30) Foreign Application Priority Data
Aug. 9, 2019 (GB) 1911447.9

(51) Int. Cl. G06F 30/27; G06F 30/15

(52) U.S. Cl. CPC G06F 30/27; G06F 30/15; G06F 2111/20

(57) ABSTRACT

A method includes providing a plurality of simulation components (101-105), each simulating operation of a distinct element of a cyber-physical system and including at least first and second simulation components (101, 102) arranged in series with one or more outputs of the first simulation component (101) being provided as input to the second simulation component (102). A plurality of output predictions are generated using a surrogate model of the first simulation component and, in response, a plurality of the second simulation components (102-1, 102-2, 102-3), or a plurality of second surrogate models, are executed in parallel. The input values of each second simulation component (102-1, 102-2, 102-3), or surrogate model corresponds to a respective one of the plurality of output predictions from the surrogate model of the first simulation component (101). Upon completion of execution of the first simulation component (10), a correct prediction of the plurality of output predictions is determined, the correct output prediction corresponding to an actual output of the first simulation component (101) at completion. In response, one or more of the plurality of second simulation components (102-1, 102-2, 102-3) or surrogate models not corresponding to the correct prediction are discarded.

### FIELD

The present application relates to methods and systems for multi-component simulation of a cyber-physical system.

### BACKGROUND

A cyber-physical system (CPS) is a co-engineered interacting network of physical and computational components. Examples of CPSs include smart cities, vehicles, and cloud computing datacentres. Such systems are becoming ever larger and more complex, with typical CPSs comprising millions of interacting elements.

In order to analyse such systems, massive-scale simulations must be built in a timely manner that can be run in reasonable time frames. Currently, there are several core challenges to massive-scale simulation, including component complexity, complexity of synchronisation, execution management and domain specialty. As such, current solutions for massive-scale simulations suffer from long execution times (days to weeks) and also the requirement for significant manual intervention and expertise with respect to both the simulated environment as well as the execution infrastructure used.

These problems can be exacerbated by the need to integrate simulations implemented on different simulation platforms in order to form a co-simulation. For example, in the automotive and aerospace domains, it is typical for separate, domain-specific simulations to have been developed for different components of the system (e.g. transmission, engine, vehicle dynamics etc in the case of a car).

It is an aim of the present application to address the above-mentioned difficulties, and any other disadvantages that would be apparent to the skilled reader from the description herein. It is a further aim of the present application to provide methods for multi-component simulation that reduce execution time and facilitate co-simulation across diverse simulation platforms.

### SUMMARY

According to the present invention there is provided an apparatus and method as set forth in the appended claims. Other features of the invention will be apparent from the dependent claims, and the description which follows.

According to a first aspect of the invention there is provided a method for multi-component simulation of a cyber-physical system, comprising:

providing a plurality of simulation components each simulating operation of a distinct element of the cyber-physical system, including at least first and second simulation components arranged in series with one or more outputs of the first simulation component being provided as inputs to the second simulation component;

generating, during execution of the first simulation component, a plurality of output predictions using a surrogate model of the first simulation component and, in response, executing a plurality of the second simulation components, or a plurality of second surrogate models each corresponding to a respective second simulation component, in parallel, the input values of each second simulation component or surrogate model corresponding to a respective one of the plurality of output predictions from the surrogate model of the first simulation component, and

determining, upon completion of execution of the first simulation component, a correct prediction of the plurality of output predictions, the correct output prediction corresponding to an actual output of the first simulation component at completion and, in response, discarding one or more of the plurality of second simulation components or surrogate models not corresponding to the correct prediction.

The plurality of simulation components may each be executable on a common simulation platform. Alternatively, the plurality of simulation components may comprise simulation components executable on two or more different simulation platforms. Accordingly, the simulation may be a multi-platform co-simulation.

Discarding the one or more of the plurality of second simulation components not corresponding to the correct prediction may comprise terminating execution of the one or more of the plurality of second simulation components not corresponding to the correct prediction. Discarding the one or more of the plurality of second simulation components or surrogate models not corresponding to the correct prediction may comprise terminating execution of further simulation components based on outputs of the second simulation components or surrogate models not corresponding to the correct prediction.

The surrogate model of the first simulation component may generate the output predictions using machine learning. The surrogate model of the first simulation component may generate the output predictions using interpolation, suitably using Kriging.

The surrogate model of the first simulation component may generate an error bound. The plurality of output predictions may comprise an upper bound of the error bound, a lower bound of the error bound and a value equidistant the upper bound and the lower bound. The plurality of predictions may be generated by sampling the error bound, suitably at a regular interval.

The first simulation component may have a first logical time step. The second simulation component may have a second logical time step different from the first logical time step. The method may further comprise:

estimating a function mapping inputs of the first simulation component to outputs of the first simulation component,

generating a surrogate model outputting a value based on the derivative of the function; and

generating inputs of the second simulation component or second surrogate model using the generated surrogate model.

The step of generating the inputs of the second simulation component or second surrogate model may comprise sampling the output of the generated surrogate model at intervals corresponding to the second logical time step.

The method may comprise mutating the outputs of the first simulation component to match the inputs of the second simulation component or surrogate model.

The method may comprise:

representing the multi-component simulation as a graph;

partitioning the graph into two or more sections; and

deploying each section of the graph to a container or virtual machine (VM) or computer device.

Each section of the graph may be deployed to a different container, VM or computer device.

The method may comprise optimising deployment of the sections of the graph during execution thereof.

The method may comprise representing the plurality of simulation components or surrogate models as an execution tree, and restricting growth of the execution tree. Suitably, the method may comprise restricting one or more of the tree size, depth or breadth.

The method may comprise identifying an output prediction of the plurality of output predictions that is unlikely to be the correct prediction, and, in response, discarding a second simulation component or a second surrogate model based on the identified output prediction before completion of the execution of the first simulation component. The method may comprise identifying the output prediction that is unlikely to be the correct prediction, by comparing the output prediction to a predetermined rule. The method may comprise identifying the output prediction that is unlikely to be the correct prediction using machine learning. The method may comprise identifying the output prediction that is unlikely to be the correct prediction by comparing a derivative of the output prediction with a derivative of an output of a simulation component of the plurality of simulation components arranged earlier than the second simulation component or second surrogate model in an execution series.

According to a second aspect of the invention there is provided a method for multi-component simulation of a cyber-physical system, comprising:

providing a plurality of simulation components each simulating operation of a distinct element of the cyber-physical system, including at least first and second simulation components arranged in series with one or more outputs of the first simulation component being provided as inputs to the second simulation component;

the first simulation component having a first logical time step and the second simulation component having a second logical time step different from the first logical time step,

estimating a function mapping inputs of the first simulation component to outputs of the first simulation component,

generating a surrogate model outputting a value based on the derivative of the function; and

generating inputs of the second simulation component or a surrogate model of the second simulation component, using the generated surrogate model.

The step of generating the inputs of the second simulation or surrogate model of the second simulation component may comprise sampling the output of the generated surrogate model at intervals corresponding to the second logical time step.

Further preferred features of the method of the second aspect are defined hereinabove in respect of the method of the aspect and may be combined in any combination.

According to a third aspect of the invention there is provided a system comprising at least one computing device, the computing device comprising:

at least one processor; and

at least one memory storing instructions which, when executed by the at least one processor, cause the computer device to perform any of the methods set forth herein.

Further preferred features of the third aspect are defined hereinabove in respect of the methods of the first and second aspect and may be combined in any combination.

According to a further aspect of the invention there is a tangible non-transient computer-readable storage medium is provided having recorded thereon instructions which, when implemented by a computer device, cause the computer device to be arranged as set forth herein and/or which cause the computer device to perform any of the methods set forth herein.

### BRIEF DESCRIPTION OF DRAWINGS

For a better understanding of the invention, and to show how embodiments of the same may be carried into effect, reference will now be made, by way of example only, to the accompanying diagrammatic drawings in which:

FIG. 1 is a schematic diagram of an example of a multi-component simulation;

FIG. 2 is a schematic flowchart of a process of deploying an example multi-component simulation;

FIG. 3 is a schematic flowchart showing the process of step S203 of FIG. 2 in more detail;

FIG. 4 is an illustration of graph coarsening;

FIG. 5 is a schematic flowchart of an example method for multi-component simulation;

FIG. 6 is an organisational diagram illustrating the execution flow of the method of FIG. 5;

FIG. 7 is a schematic flowchart of an example method for multi-component simulation;

FIG. 8 is schematic diagram illustrating the method of FIG. 7; and

FIG. 9 is a schematic diagram of an example method for multi-component simulation.

Corresponding reference numerals are used to refer to corresponding elements throughout the drawings. In the drawings, corresponding reference characters indicate corresponding components. The skilled person will appreciate that elements in the figures are illustrated for simplicity and clarity and have not necessarily been drawn to scale. For example, the dimensions of some of the elements in the figures may be exaggerated relative to other elements to help to improve understanding of various example embodiments. Also, common but well-understood elements that are useful or necessary in a commercially feasible embodiment are often not depicted in order to facilitate a less obstructed view of these various example embodiments.

### DESCRIPTION OF EMBODIMENTS

In overview, examples of the invention provide a multi-component simulation method in which components of the simulation are arranged in series. In order to avoid a delay in execution caused by a second component waiting for output from a first, earlier, component to complete execution, the method generates a plurality of predictions of the output of the first, earlier, component. These predictions are used as inputs for the parallel execution of several versions of the second component, thereby removing the delay. Once the first component has finished execution, whichever version is based on an accurate prediction is retained, with the other components pruned or discarded.

Other examples of the invention provide a multi-component simulation method in which a first component and second component operate on different logical time steps. The derivative of a surrogate model of the first component is used to connect the two components, so as to provide a more accurate representation of the required value.

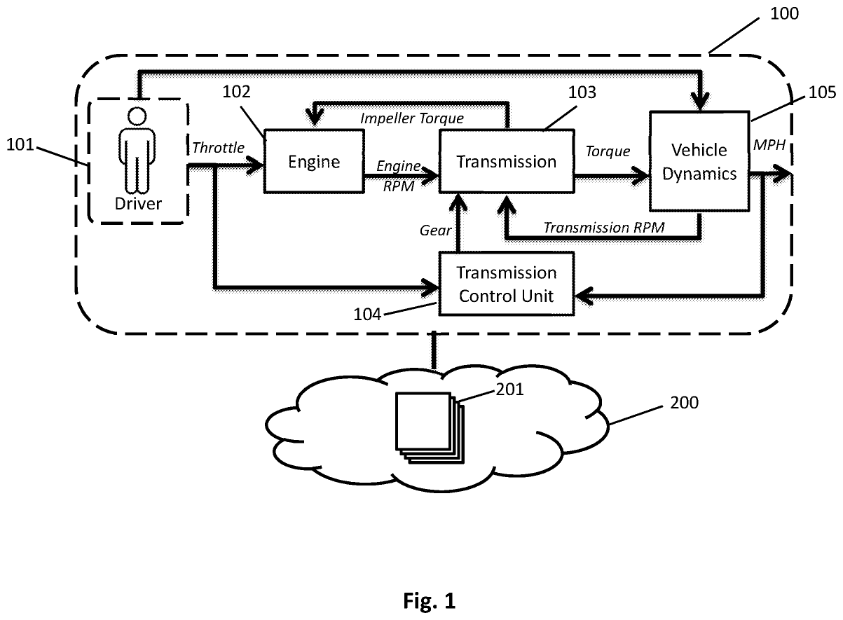

FIG. 1 is a schematic representation of an example multicomponent simulation 100 of a cyber-physical system (CPS). In the example shown, the simulation 100 simulates a car. The simulation 100 comprises a plurality of simulation components 101-105. Each simulation component 101-105 is a discrete component of the system, in the sense that it is separate component. Furthermore, each of the simulation components 101-105 simulates a distinct component of the car. For example, a first of the components 101 simulates the driver of the car, a second of the components 102 simulates an engine of the car, a third of the components 103 simulates the transmission of the car, a fourth of the components 104 simulates the transmission control unit (TCU) of the car, and a fifth of the components 105 simulates the vehicle dynamics.

As shown in FIG. 1, the components 101-105 are connected, such that output from one component forms input to one or more other components. For example, the revolutions per minute (RPM) of the engine simulation component 102 provides input to the transmission component 103. The torque of the transmission component 103 provides input to the vehicle dynamics component 105. In addition, the impeller torque of transmission component 103 provides input back to engine simulation component 102. Accordingly, the simulation 100 includes feedback cycles.

It will be appreciated that this is a drastically simplified example of a multicomponent simulation, in order to illustrate the invention. Of course, in practice, each simulation may comprise hundreds, thousands or even millions of discrete, connected components. Furthermore, although the simulation 100 shows components 101-105 having one, two or three outputs and one, two or three inputs, it will be appreciated that, in practice, each component may have more inputs and outputs.

Furthermore, it will be appreciated that, in addition to simulation components, the simulation 100 may comprise one or more “in-the-loop” components, which interact with the simulation 100 but are not under the control of the simulation 100. For example, as an alternative to simulating the driver, the simulation 100 could interact with a human driver (i.e. a human-in-the-loop).

Whilst the components are logically arranged in series such that the output from one component forms input to one or more other components, in some examples the execution of the components may not be carried out strictly in series. Instead, as would be appreciated by those skilled in the art, the components may be executed in parallel. It will be appreciated that simulations comprising cycles may be decomposed and ordered for execution as appropriate.

FIG. 1 further illustrates a machine cluster 200 configured to execute the simulation 100. The machine cluster 200 comprises a plurality of computer devices (e.g. servers) 201, each computer device 201 comprising at least one compute element (e.g. one or more of a central processing unit (CPU), graphics processing unit (GPU), Field-Programmable Gate Array (FPGA)) and a memory. The computer devices 201 are connected by a suitable network. In one example, the plurality of computer devices 201 are configured to execute one or more virtual machines (VMs) or containers.

The computer devices 201 of the machine cluster 200, and/or the VMs and containers thereof, are configured to execute one or more components 101-105 of the simulation 100. The machine cluster 200 may comprise distributed compute infrastructure (e.g. a Cloud).

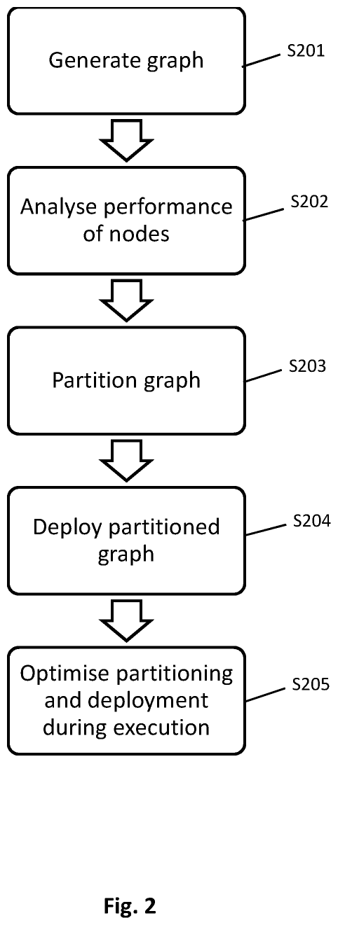

Deployment of the simulation components 101-105 across the machine cluster 200 will now be discussed with reference to FIG. 2.

FIG. 2 shows an example process of deploying the simulation 100 across the machine cluster 200.

Firstly, in step S201, the simulation 100 is represented as a graph. It will be appreciated that the components 101-105 and the inputs/outputs effectively form a graph, with the components as the nodes of the graph and the inputs/outputs forming directed edges of the graph. Accordingly, a graph can be derived representing the simulation 100. In the description herein, the terms “node” and “component” are used interchangeably.

Next, in step S202, the computational performance of each node are estimated. This may involve determining an execution time of the node per time step of the simulation, scalability with multiple VMs, etc. The determined performance forms the weight of the node, such that more computationally expensive nodes are weighted more heavily.

Next, in step S203, the graph is partitioned in to two or more sections.

Next, in step S204, the partitioned graph is deployed across the machine cluster 200. In particular, each section of the graph is deployed to a separate container, VM or computer device 201 and executed. It will be appreciated that the machine cluster 200 may comprise appropriate scheduling and deployment software to efficiently deploy each section of the graph to a container/VM/computer device 201 having appropriate compute resource available.

In step S205, the partitioning of the graph and the deployment of the sections of the graph is optimised during execution, such that if an alternative partitioning or deployment is optimal, the graph is re-partitioned and re-deployed accordingly.

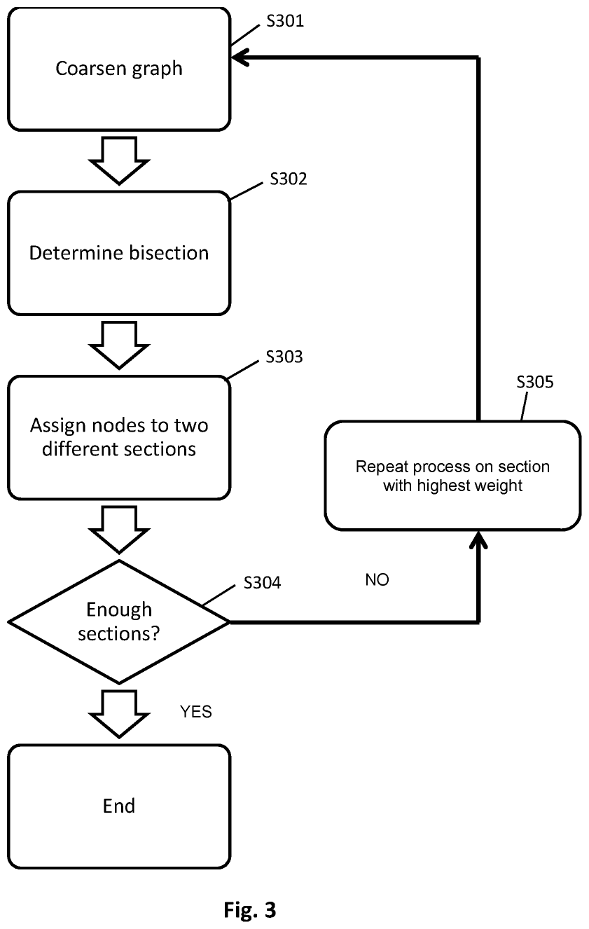

FIG. 3 illustrates an example graph partitioning process of step S203 in more detail. The graph partitioning algorithm is intended to optimise the weight balancing of the sections of the graph. In other words, the aim of the process is to ensure that the sections of the graph are weighted as evenly as possible. Furthermore, the algorithm also seeks to minimise the number of external edges (i.e. edges that extend between nodes in different sections).

Firstly, in step S301, the graph is coarsened. The step of coarsening the graph groups together a plurality of nodes so that are considered as a single node by the partitioning process, thereby reducing the number of nodes to consider when determining the optimal partition. FIG. 4 illustrates a first, original graph G1 and a second graph G2 that has been coarsened.

A modified Maximal Matching method is employed to coarsen the graph, as follows.

Firstly, each unmatched node is matched with an unmatched neighbour of the highest score. The coarsening score function depends on the weight of the edge and the weight of the neighbour.

If a node has no unmatched neighbours, it is marked as matched. This process is repeated until all nodes are matched. The new nodes in the coarse graph have a total weight of the nodes and edges it contains. Two nodes in the coarse graph are determined to have the weight of the total weight of the nodes and edges it contains. Two nodes in the coarse graph are connected if there is an edge between them in the original graph. If there are multiple edges connecting two nodes in the coarse graph, they are collapsed into a single edge with its weight corresponding to the total weight of the multiple edges.

In one example, the coarsening score function of two nodes A and B is:

$$CoaScore ( A , B ) = \frac{Weight of Edge ( A , B )}{Weight of A + Weight of B}$$

Accordingly, the algorithm prefers combining edges with higher weights and prevents the formation of overweighted nodes that would not be separable during the partitioning.

Next, in step S302, a highest scoring bisection of the coarsened graph is determined. In general, determining the highest scoring bisection involves searching the possible bisections to choose the highest scoring bisection. In one example, this can be carried out by exhaustively searching all possible bisections, on the basis that the coarsening of the graph sufficiently reduces the number of possibilities to make this calculable in an acceptable amount of time. In further examples, other search algorithms (e.g. a breadth-first search) may be employed.

The partition score for the partition of a graph into two sections P and Q may be calculated as follows:

$$ParScore ( P , Q ) = \frac{1}{max ( W ( P ) , W ( Q ) ) * s * W e * ( 1 + k )}$$

Where W(P) and W(Q) are the weight of each section, We is the total weight of edges being cut, s is the communication constant and k is the connectivity preference. The weight of each section is defined as the total weight of the nodes in the section plus the weight of all edges internal to the section. Example values of s and k are 100 and 0.5 respectively.

Next, in step S303, the nodes of the graph are assigned to two different sections, based on the determined highest scoring bisection.

In step S304, it is determined whether a sufficient number of sections has been created. If yes, then the process ends. If there are not a sufficient number of sections, the weight of each section of the graph is calculated in step S305, and then steps S301-304 are repeated for the section of the graph with highest weight. Accordingly, the graph is repeatedly bisected until a desired number of sections are derived.

It will be appreciated that other graph partitioning algorithms may be applied to obtain the partitioned graph.

It will be further appreciated that, in some examples, the simulation 100 is a co-simulation in which one or more of the components 101-105 is executed using a different simulation platform to the other components (e.g. one node is built using MATLAB® and Simulink®). In such examples, each component which is executed on a different platform forms its own partition of the graph.

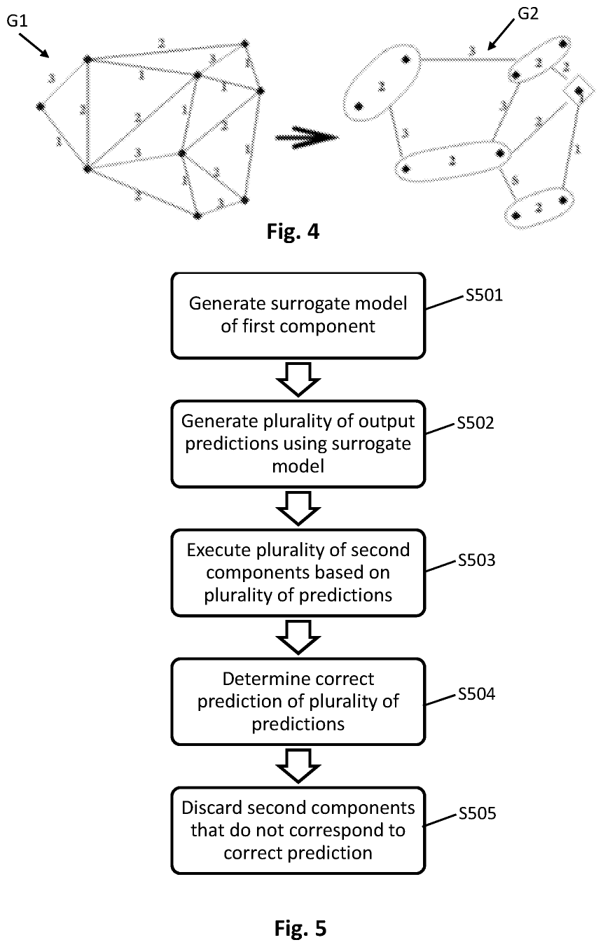

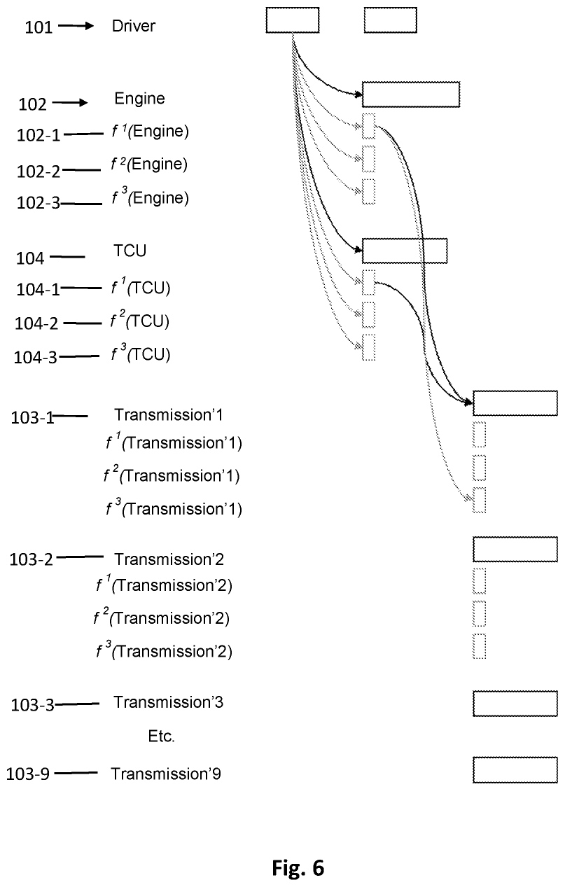

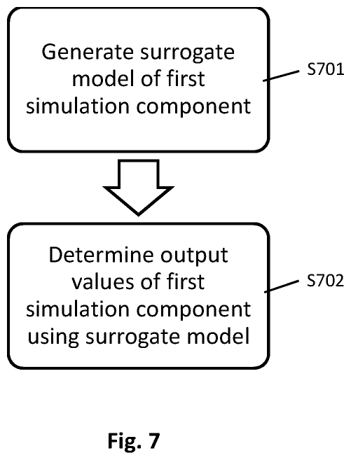

Turning now to FIGS. 5 and 6, an example method for multi-component simulation is illustrated. As it will be appreciated from the description herein, each node or component 101-105 receives input from at least one other component 101-105 of the simulation 100. Accordingly, at each time step of the simulation 100, components await the completion of the execution of a previous component in order to receive the input. In circumstances where a first component has a long execution time, the slow-running first component would ordinarily hold up the execution of later components (hereinafter referred to as second components) that are awaiting input based on the output of first component.

Firstly, in step S501, a surrogate model of the first component is generated. In particular, the input values and output values of the first component are analysed in real-time to generate a surrogate model of the derivatives. Accordingly, a model is derived that estimates or predicts change of the output values based on change of the input values. The initial surrogate may be generated from previously-collected data, for example from previous simulation runs or previous time steps of the simulation. For example, the derivative may be learned by devising a DOE (design of experiments) that appropriately covers the input and output space of the simulation component. Accordingly, given a previous set of inputs resulting in a state x and a new set of inputs i′, the surrogate model can determine the result of f′(x, i′).

A number of machine learning methods are available for the generation of a surrogate model of a simulation component, including interpolation and sampling. In one example, an interpolation algorithm is employed that provides an error estimation of the output of the surrogate model. The interpolation algorithm may be a Kriging (also referred to in the art as Gaussian process regression) algorithm, configured to provide an error-bound associated with the output, for example using the distribution of previous data values (i.e. the covariance).

Accordingly, as input is received to the first component (e.g. from other components), the same input is directed to the surrogate model of the first component, which can accordingly predict the possible new output values of that node.

Of course, it will be appreciated that most nodes comprise multiple input values and output values, and accordingly, the surrogate represents the derivative of the function mapping the input values to the output values. The use of the derivative allows the surrogate to map the relationships between all the inputs and outputs in a matrix, or the Quality Function Deployment (QFD) framework or as a set of partial differential equations. A published example of the QFD framework using derivatives can be found in Dickerson C E; Clement S J; Webster D; McKee D; Xu J; Battersby D (2015), “A service oriented virtual environment for complex system analysis: Preliminary report”. In: Proceedings of 10th System of Systems Engineering Conference (SoSE), 2015, pp. 152-157, ISBN 978-1-4799-7611-9, the contents of which are incorporated herein by reference.

Next, in step S502, a plurality of predictions are generated by the surrogate model representing an appropriate spread of possible outputs. As noted above, the surrogate model provides an error-bound, which effectively defines an uppermost prediction (i.e. an upper bound) and a lowermost prediction (i.e. a lower bound), between which possible values will range. This range is sampled to generate the predictions.

In one example, the upper bound, lower bound and the estimate value (i.e. the value equidistant the upper and lower bound) are used to generate three predictions. In other examples, the range may be sampled more frequently (e.g. at regular intervals across the range, or according to some other distribution), and as a result there could be more than 3 predictions used. In one example, the sampling (and therefore number of predictions) is defined by a user specified error tolerance parameter based on the ratio:

RANGE_BETWEEN_PREDICTIONS/PREDICTION

Next, in step S503, if the second component in the workflow needs results from the first component before the first component finishes its actual computation, a plurality of second components are created and executed, with each node receiving a distinct one of the plurality of predictions. In one example, the second components are executed in parallel. Accordingly, if the surrogate model of the first component generates three possible predictions of the output, three copies of the second component are created—one per prediction. Therefore, the second component(s) need not wait until completion of the first component before being executed.

In some examples, rather than executing the second components, surrogate models of the second components are executed based on the predictions. Accordingly, references to second simulation components throughout should be interpreted as references to either second simulation components or surrogate models of the second simulation components.

Next, in step S504, upon completion of the execution of the first simulation component, the method determines which of the plurality of predictions generated was correct. In other words, the method compares each prediction to the actual output of the first simulation component, and determines which of the predictions corresponds to the actual output. In one example, the prediction which corresponds most closely to the actual output (i.e. with the lowest error) is selected.

Next, in step S505, the plurality of second components that do not correspond to the correct prediction are discarded. In other words, only the second component that corresponds to the correct prediction is retained.

In one example, second components that do not correspond to the correct prediction and which are still being executed are terminated.

Of course, it will be appreciated that the second components may have completed their execution before completion of the execution of the first component. In such a circumstance, further components (i.e. third components) may have been executed based on the output of the now-completed second components. In other words, an execution tree forms, with each node having a plurality of dependent components, each based on a prediction of the node's output. Accordingly, in this situation, any further simulation component being executed on the basis of the incorrect prediction is terminated. In other words, any sub-trees rooted at a node representing an incorrect prediction are terminated.

In certain circumstances, the unchecked parallel execution of plural second components based on the plurality of predictions may lead to the generation of a large number of second simulation components. For example, the execution tree of components could cascade to several layers, whilst waiting on a slow-running simulation component. In one example, the method comprises a mitigation mechanism, to prevent this potential state explosion. The mitigation mechanism controls the growth of the execution tree of simulation components. For example, to minimise the breadth of the tree, the simulations and surrogates are run just-in-time (possibly with a buffer) for their results to be ingested. In a further example, the mitigation mechanism enforces restrictions on one or more of the tree size, depth, or breadth. Accordingly, when the depth, breadth or overall size of the tree reaches a predetermined maximum value, new nodes are prevented from being generated until execution of existing nodes is completed.

In another example, the execution tree is pruned during execution so that second simulation components based on predictions that are unlikely to correspond to the correct prediction may be discarded.

For example, rules may be employed to assess an output prediction. If a rule indicates that the output prediction is unlikely to be a correct prediction, for example because it is outside a predetermined range specified by a rule, then execution of the second component may be terminated. The rules may be derived from examination of previous simulation runs.

In further examples, machine learning may be employed to identify improbable predictions. For example, historic data such as previous simulation runs may provide labelled training data, indicating which predictions were correct, which can be used in supervised machine learning. It will be appreciated that in many settings, a particular simulation is run a very large number of times, over weeks, months or years, resulting in a large amount of historical data.

In still further examples, pattern matching of the shapes/gradients of outputs of a component may be used to identify improbable predictions, or symbolic regression may be employed to identify improbable predictions for pruning.

In another example, an improbable prediction may be identified based on an analysis of the derivative of the prediction with respect to the derivative of one or more preceding simulation components. For example, if a prediction constitutes a significant increase or decrease in the rate of change of the output in comparison to the output provided by previous simulation components in the chain of execution, this may be indicative of an improbable prediction. Again, rules, thresholds or machine learning may be employed to identify such improbable predictions.

When an improbable prediction is identified, the second simulation component based on it may be terminated, and in addition any further simulation component being executed on the basis of the improbable prediction is then also consequently terminated. In other words, any sub-trees rooted at a node of the execution tree representing a prediction deemed improbable are terminated, so as to prune that branch of the executions tree.

Accordingly, instead of or in addition to applying the restrictions on tree size discussed above, proactive action may be taken to manage the growth of the execution tree during the simulation (i.e. before completion of the first simulation component) by removing tree branches based on poor predictions.

A worked example of the exemplary method of FIG. 5 will now be discussed with reference to FIG. 6. FIG. 6 shows the execution flow of the above-described method in relation to the simulation 100.

At time t0 of the simulation 100, the driver component 101 is executed and carries a first run.

At time t1 of the simulation 100, the driver component 101 is executed again, and carries out a second run. Rather than waiting for the completion of the second run of the driver component, three copies of the engine component 102, labelled 102-/102-2/102-3, are executed based on three predictions of the output of the driver component 101.

Similarly, three copies of the TCU component 104, labelled 104-1/104-2/104-3, are executed based on three predictions of the output of the driver component 101.

In addition, the transmission component 103, which relies on input from both the TCU component 104 and the engine component 102 begins execution. As three copies of each of the TCU component 104 and engine component 102 are being executed, nine copies of the transmission component 103 are executed, corresponding to the combinations of the copies of the engine component 102-1/102-2/102-3 and TCU component 104-1/104-2/104-3.

It will be understood that this process continues, with the vehicle dynamics component 105 being similarly executed based on output predictions from the other components.

Subsequently, execution of the engine component 102 is completed. At this point, any components based on predictions not corresponding to the actual output of the engine component 102 are pruned from the execution tree and terminated. As other components complete, the tree is repeatedly pruned, so as to discard branches based on incorrect predictions.

In one example, the actual error of the simulation 100 can be calculated by comparing the actual simulation result to the surrogate results, given that they may not be exactly the same. This error can then be propagated downstream and accumulated to give an estimation of the overall simulation error when using surrogates. This is because, even when using the error bound method for choosing the predictions, the output of the real simulation is unlikely to perfectly match that selection. In one example, if the accumulated error becomes greater than some predetermined threshold, a halting mechanism is required which may involve the use of techniques such as checkpointing (or other appropriate mechanisms).

In one example, the surrogates are used to provide instantaneous values for dependent simulations for a single timestep to allow all process to complete in parallel if it is undesirable to wait for the correct results from the slow one. The error introduced into the simulation can then be calculated by comparing the actual value against the used surrogate value. The error accumulation provides error bounds on the simulation so an engineer can decide whether to trust the results or not.

FIG. 7 shows a further exemplary method for multi-component simulation of a cyber-physical system.

As discussed above, it will be appreciated that, in some examples, the simulation 100 is a co-simulation in which one or more of the components 101-105 is executed using a different simulation platform to the other components (e.g. one node is built using MATLAB® and Simulink®). In such examples, and in other situations (e.g. when nodes have been built on the same platform but at different times and/or with different requirements), the logical time step of each component may not be equal. That is to say, the simulation 100 may not have a global clock to which all components are aligned.

For example, a first simulation component may have a first logical time step or frequency of 10 seconds. Accordingly, the first simulation component simulates the output of the underlying component of the cyber-physical system at 10 s intervals. A second simulation component may for example instead have a second logical time step of 13 s.

Accordingly, it will be appreciated that, in order to generate input to the second component based on the first component, values that reflect the output of the first component at 13 s intervals must be obtained. It is therefore necessary to estimate the output of the first component between its time steps.

In step S701, a surrogate model is generated of a first simulation component. As discussed above, the surrogate model represents an estimate of the derivative of the function mapping the input values to the output values.

In step S702, the surrogate model is used to determine the value of the first simulation component, and this value is used as the input to the second simulation component. In detail, as the surrogate model represents the derivative of the underlying function mapping the input values to the output values, it can be used to more accurately determine the value of the output values at times between the logical time steps of the first component.

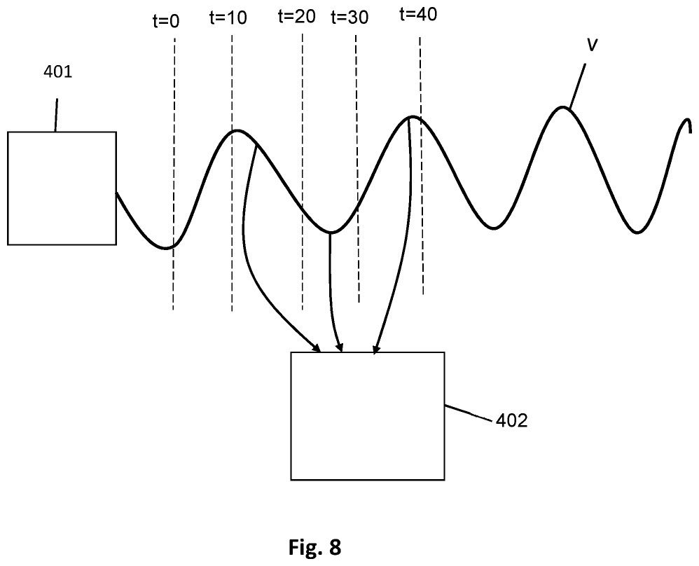

FIG. 8 illustrates the method of FIG. 7. FIG. 8 shows a surrogate model 401 of a first simulation component outputting a value V. The first component has a time step of 10 seconds. The second simulation component 402 operates on a time step of 13 s. Accordingly, input for the second simulation component 402 can be obtained by sampling the surrogate model at t=13, t=26, t=39 and so on.

This allows a more accurate reflection of the expected value of the first simulation component at the required time, than other methods such as averaging, zero-order hold and first-order hold.

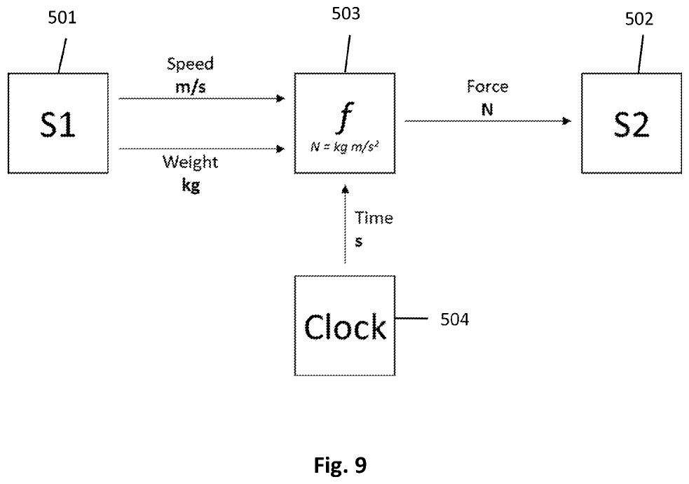

FIG. 9 illustrates a further exemplary method for multi-component simulation of a cyber-physical system. In some examples, the outputs of a first simulation component 501 may not perfectly match the inputs to a second simulation component 502. Therefore an intermediary block 503 is added in-between the 2 simulations that mutates the outputs appropriately.

In one example, the intermediary block 503 is configured to merge multiple outputs of the first simulation component 501 into fewer inputs for the second simulation component 502. For example, outputs of the first simulation component 501 in kg and m/s² could be merged to output a value in newtons (N), by applying the appropriate conversion formula. In other examples, the intermediary block 503 is configured to split outputs to more inputs, e.g. the reverse of “N” to “kg” and “m/s2”. In a further example, the intermediary block 503 may allow for time integration, e.g. where the output of the first simulation component 501 does not include a time element, and so the intermediary block 503 adds the time element from a global clock 504.

The intermediary block 503 may exist between a first simulation component 501 and one or more second simulation components 502. The mutations are instantaneous in terms of simulation logical time and are synchronised to the second simulation component, i.e. driven by their consumers.

Advantageously, the above-described methods and systems prevent substantial delay in the execution of a simulation by running simulation components ahead of time based on predicted output of slow-running simulation components. This ensures guaranteed result accuracy in a timely manner. Given the massive compute requirements of highly complex multi-component simulations of cyber-physical systems, these methods and systems can significantly accelerate execution of such simulations. As a consequence, the methods and systems described herein remove design constraints placed upon the user of the simulation by the need to avoid slow execution of the simulation. This gives the user further freedom to develop more complex simulations.

Advantageously, the above-described methods and systems enable the accurate connection of simulation components having differing time steps. Accordingly, simulation accuracy is improved for co-simulations having simulation components implemented on diverse platforms.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method for multi-component simulation of a cyber-physical system, comprising:
providing a plurality of simulation components each simulating operation of a distinct element of the cyber-physical system, including at least first and second simulation components arranged in series with one or more outputs of the first simulation component being provided as inputs to the second simulation component;
generating, during execution of the first simulation component, a plurality of output predictions using a surrogate model of the first simulation component and, in response, executing a plurality of the second simulation components, or a plurality of second surrogate models each corresponding to a respective second simulation component, in parallel, the input values of each second simulation component or surrogate model corresponding to a respective one of the plurality of output predictions from the surrogate model of the first simulation component, and
determining, upon completion of execution of the first simulation component, a correct prediction of the plurality of output predictions, the correct output prediction corresponding to an actual output of the first simulation component at completion and, in response, discarding one or more of the plurality of second simulation components or surrogate models not corresponding to the correct prediction.

2. The method of claim 1, wherein the plurality of simulation components comprises simulation components executable on two or more different simulation platforms.

3. The method of claim 1, wherein discarding the one or more of the plurality of second simulation components or surrogate models not corresponding to the correct prediction comprises terminating execution of the one or more of the plurality of second simulation components or surrogate models not corresponding to the correct prediction.

4. The method of claim 1, wherein discarding the one or more of the plurality of second simulation components or surrogate models not corresponding to the correct prediction comprises terminating execution of further simulation components or surrogate models based on outputs of the second simulation components not corresponding to the correct prediction.

5. The method of claim 1, wherein the surrogate model of the first simulation component generates the output predictions using machine learning.

6. The method of claim 1, wherein the surrogate model of the first simulation component generates using Kriging.

7. The method of claim 1, wherein the surrogate model of the first simulation component generates an error bound.

8. The method of claim, wherein the plurality of output predictions comprises an upper bound of the error bound, a lower bound of the error bound and a value equidistant the upper bound and the lower bound.

9. The method of claim 7, wherein the plurality of predictions is generated by sampling the error bound.

10. The method of claim 1, wherein:
the first simulation component has a first logical time step and the second simulation component has a second logical time step different from the first logical time step, and
the method further comprises:
estimating a function mapping inputs of the first simulation component to outputs of the first simulation component,
generating a surrogate model outputting a value based on the derivative of the function; and
generating inputs of the second simulation component or second surrogate model using the generated surrogate model.

11. The method of claim 10, wherein the step of generating the inputs of the second simulation component or second surrogate model comprises sampling the output of the generated surrogate model at intervals corresponding to the second logical time step.

12. The method of claim 1, comprising mutating the outputs of the first simulation component to match the inputs of the second simulation component or surrogate model.

13. The method of claim 1, comprising:
representing the multi-component simulation as a graph;
partitioning the graph into two or more sections; and
deploy each section of the graph to a container or virtual machine (VM) or computer device.

14. The method of claim 13, wherein each section of the graph is deployed to a different container, VM or computer device.

15. The method of claim 13, comprising optimising deployment of the sections of the graph during execution thereof.

16. The method of claim 1, further comprising:
representing the plurality of simulation components or surrogate models as an execution tree, and
restricting growth of the execution tree.

17. The method of claim 1, further comprising:
identifying an output prediction of the plurality of output predictions that is unlikely to be the correct prediction, and
in response, discarding a second simulation component or second surrogate model based on the identified output prediction.

18. A system comprising at least one computing device, the computing device comprising:
at least one processor; and
at least one memory storing instructions that, when executed by the at least one processor, cause the computer device to perform the method of any preceding claim.

19. A tangible non-transient computer-readable storage medium having recorded thereon instructions which, when implemented by a computer device, cause the computer device to perform the method of claim 1.
